(19) United States
(12) Patent Application Publication
(10) Pub. No.: US 2005/0220410 A1
(43) Pub. Date: Oct. 6, 2005

(54) Low reflectance optical coupling

(75) Inventor: Ross Job Thompson, Bridgewater, NJ (US)

Correspondence Address: The Whitaker Corporation, Suite 140, 4550 New Linden Hill Road, Wilmington, DE, 19808, US

(73) Assignee: The Whitaker Corporation (M/S 324-01), Wilmington, DE (US)

(21) Appl. No.: 10/977,892

(22) Filed: Oct. 29, 2004

Related U.S. Application Data
(60) Provisional application No. 60/515,369, filed on Oct. 29, 2003.

(51) Int. Cl. G02B 6/36

(52) U.S. Cl. 385/39; 385/50; 385/78

(57) ABSTRACT

An optical coupling comprising: (a) a housing having first and second ends and having an optical axis, the first end having a first cavity for receiving an optical component, the second end having a second cavity for receiving a single mode fiber along the optical axis; and (b) a section of a multimode fiber disposed within the housing and along the optical axis between the first and second cavities, the multimode fiber having a first fiber end and a second fiber end, the first fiber end interfacing with air, the second fiber end being polished to optically couple with the single mode fiber through physical contact.

### CROSS REFERENCE TO RELATED APPLICATIONS

This application claims priority benefit to U.S. Provisional Application No. 60/515,369 filed on Oct. 29, 2003, which is incorporated herein by reference.

### FIELD OF INVENTION

The invention relates generally to an optical package, and, more specifically, to an optical package comprising a cavity for receiving a single mode fiber.

### BACKGROUND

Optical packages are ubiquitous in optical systems. As used herein, the term “optical package” refers to any assembly of discrete optical components which are optically coupled to each other. Examples of optical packages include TO cans for transmitting and receiving optical signals, optical benches for manipulating optical signals, and add/drops for multiplexing and demultiplexing optical signals. Of particular interest herein are optical packages in which a single mode fiber is optically connected to an optical component, such as another fiber or an optoelectric device (OED).

Referring to FIG. 1, a traditional optical package is shown for optically coupling a single mode fiber to an OED. This particular package is the optical connector interface (OCI) 10 for a TO-can. The OCI 10 is mounted to a header (not shown) at its end 6. The OCI 10 functions as the interface between an optical single mode fiber 1 and an optoelectric device (OED), which, may be, for example, a photodiode mounted on the header. The OCI 10 comprises a cavity 3 to receive a ferrule 8 containing the fiber and align the fiber along the optical axis A of the OCI 10. Light emitting from the end face of the fiber 1 is optically coupled with the OED through the ball lens 4. There is an air gap between the single mode fiber and the ball lens and between the ball lens and the OED. A window 2 is disposed on the end 6 and serves to hermetically seal the header once the header is attached to the OCI at end 6.

Critical to the performance of optical packages is minimizing optical losses. Optical losses tend to occur at optical couplings due to a variety of factors including misalignment of the optical components and reflective losses. Of particular interest herein are reflective losses. One source of reflective loss is a mismatch of the refractive indices of two mediums through which light propagates. For example, in an optical fiber, reflection loss occurs at any discontinuity of refractive index such as an air-glass interface existing at a fiber end face. Any medium through which light can propagate has a particular refractive index. When light propagates between mediums with different refractive indices, its rays are redirected. Specifically, as light strikes the interface of two mediums having different refractive indices, one portion of the light will pass through the interface and continue forward along a refracted path while another portion of the light will not pass through the interface, but instead will be reflected back into the medium from which it came. Such reflection is called “Fresnel reflection”. The energy of the refracted light that continues in a forward direction is equal to the energy of the incident light less the energy of the Fresnel reflection. Thus, Fresnel reflection represents a loss to the total optical energy that can be propagated forward. When expressed as a ratio of the reflected power to incident power, the loss is known as “reflectance”.

Reflectance can also be expressed in terms of the refractive indices of the two mediums creating the interface. Where one of the mediums is air (which has a refractive index of 1.0), this expression is stated as follows:

$$Loss ( dB ) = 10 {log}_{10} [ 1 - {( \frac{n - 1}{n + 1} )}^{2} ]$$

where n is the refractive index of the second medium.

For optical fibers, this mismatch in refractive indices of air and glass theoretically limits reflectance at the air-glass interface to −14 decibels (dB) or higher.

An optical package should be designed to minimize reflectance. Perhaps the most effective approach for minimizing reflectance is to maintain physical contact (PC) between optical components. If two optical components are in physical contact and if the optical components have similar refractive indexes, then the Fresnel reflection will be relatively small. Unfortunately, applications frequently require air gaps between components. For example, in the OCI 10 considered above, there is an air gap optical coupling between the fiber and the lens to facilitate focusing of the optical beam. Additionally, in high vibration applications, there is a preference to avoid PC between components since relative movement between the components (caused by the vibration) may damage them. Furthermore, in ruggedized connectors, it is often preferred to use an air gap to facilitate expanding the beam spot size and therefore make the beam more tolerant of dirt and debris in its optical path. In situations like these where air gaps are necessary or preferred, the low loss PC coupling is not available.

Therefore, there is a need for a low reflectance optical coupling between a single mode fiber and another component through an air gap. The present invention fulfills this need among others.

### SUMMARY OF INVENTION

The present invention provides for an improved air gap optical coupling between a single mode fiber and another optical component. Specifically, the optical coupling of the present invention uses a section of multimode fiber at the interface of the single mode fiber and the air gap. One end of the multimode fiber is in physical contact with the single mode fiber. As mentioned above, this is a low reflectance optical coupling. The other end of the multimode fiber interfaces with the air gap. Although a beam emanating from the multimode fiber and into the air gap will face significant Fresnel reflection at the interface of the fiber and air, reflected light is unlikely to optically couple back into the single mode fiber. That is, since the diameter of a multimode fiber core is significantly larger than that of a single-mode fiber, light propagating in the multimode fiber is unlikely to couple with the single-mode fiber. Therefore, the multimode fiber stub acts essentially as a one-way check valve for light, allowing light to emanate from the single-mode fiber into the multimode fiber, but preventing reflective light from coupling back into the single-mode fiber. Preferably, the air/fiber interface of the multimode fiber is angled such that reflected light is projected into and absorbed by the fiber's cladding to further reduce reflective loss.

In addition to reducing reflectance, the optical coupling configuration of the present invention also offers a number of other advantages over the prior art. For example, the optical package can have relaxed tolerance. Specifically, the housing assembly can be produced using low cost machining techniques since alignment of the multimode fiber with a single mode fiber does not require a high degree precision. That is, the relatively large core diameter of the multimode fiber provides a large target for receiving optical signals from the single-mode fiber. Providing that the optical component which is coupled to the multimode fiber does not require the alignment precision of a single mode light (e.g., a photodiode), the reduction in precision of the optical beam from the single mode fiber to the multimode fiber will have no detrimental affect on the optical package. Furthermore, since the multimode fiber is so short (i.e., it is preferably only a stub), the characteristically higher attenuation losses of a multimode fiber over a single-mode fiber will not be noticed.

In addition to the relaxing the tolerances of the package, the optical coupling of the present invention also allows critical alignments to be made internal to the housing before mating with the single mode fiber. That is, rather than dealing with radial positioning an angled single mode fiber in the optical package, which requires keying the single mode fiber to the optical package, the present invention allows the angled face of multimode fiber to be positioned and fixed within the housing during assembly and prior to connection with the single mode fiber. This way, the radial orientation of the angled fiber end face is set in a controlled manufacturing environment and the single mode fiber can be introduced at a later time without regard to radial alignment. This reduces costs and simplifies coupling of the single mode fiber with the optical package.

Accordingly, one aspect of the present invention is an optical coupling having a multimode fiber interposed between the single-mode fiber and an air gap to produce an interface between multimode fiber and the air gap and between the multimode fiber and the single-mode fiber. In a preferred embodiment, the optical coupling comprises: (a) a housing having first and second ends and having an optical axis, the first end having a first cavity for receiving an optical component, the second end having a second cavity for receiving a single mode fiber along the optical axis; and (b) a section of a multimode fiber disposed within the housing and along the optical axis between the first and second cavities, the multimode fiber having a first fiber end and a second fiber end, the first fiber end interfacing with air, the second fiber end being polished to optically couple with the single mode fiber through physical contact.

Another aspect of the invention is an optical package comprising the optical coupling described above. In a preferred embodiment, the optical package comprises: (a) a housing having first and second ends and having an optical axis, the first end having a first cavity for receiving an optical component, the second end having a second cavity for receiving a single mode fiber along the optical axis; (b) a section of a multimode fiber disposed within the housing and along the optical axis between the first and second cavities, the multimode fiber having a first fiber end and a second fiber end, the first fiber end interfacing with air, the second fiber end being polished to optically couple with the single mode fiber through physical contact; (c) an optical component disposed in the first cavity; and (d) a single mode fiber disposed within the second cavity. In a particularly preferred embodiment, the optical package is an OCI.

### BRIEF DESCRIPTION OF DRAWINGS

FIG. 1 shows a cross-section of a traditional optical connector interface.

FIG. 2 shows a cross-section of the low reflectance optical connector interface including a cross section of the short stub ferrule.

FIG. 3 shows a cross-sectional detail of the low reflectance optical connector interface.

FIG. 4 shows a cut-away detail of the multimode optical fiber and ferrule stub.

FIG. 5 shows the multimode optical fiber and ferrule stub in a cross-sectional view that is orthogonal to the optical axis.

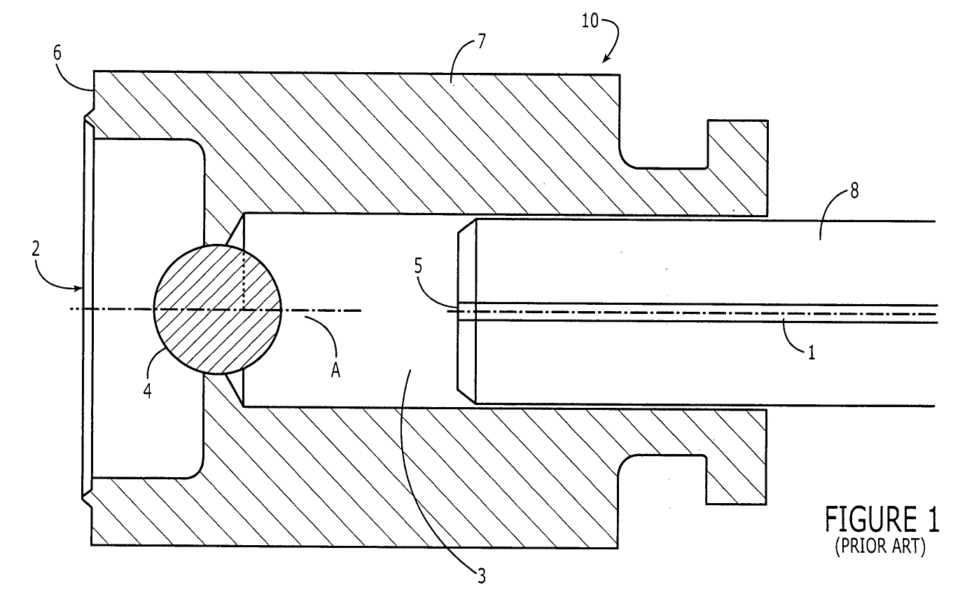

### DETAILED DESCRIPTION OF PREFERRED EMBODIMENT

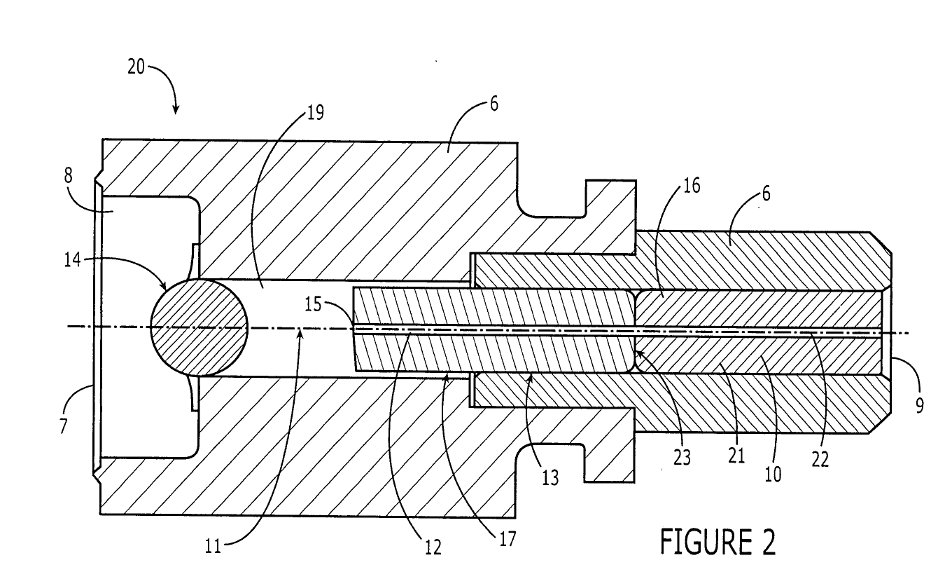

Referring to FIGS. 2-5, an optical coupling of the present invention is shown. For illustrative purposes, an optical connector interface (OCI) 20 will be considered herein specifically. It should be understood, however, that the present invention is not limited to an OCI, but can be practiced with any optical package involving a single mode fiber with a fiber/air interface.

The OCI 20 comprises a housing 6 having an optical axis 11, a first end 7 with a corresponding first cavity 8, and a second end 9 with a corresponding second cavity 10. The housing may be integrally molded or it may be an assembly of discrete components. The first cavity 8 of the housing is designed to receive an optical component, which, in this embodiment, is a ball lens 14, and that the second cavity 10 is designed to receive a single mode fiber 22, which, in this embodiment, is contained in a ferrule 21. The ferrule 21 holds the fiber 22 such that it is aligned along the housing's optical axis 11. A section of a multimode fiber 12 is disposed inside a short ferrule stub 13. The ferrule stub 13 is positioned along the optical axis 11 between the first and second cavities of the housing, 8 and 10 respectively. The multimode fiber 12 has a first fiber end 15 and a second fiber end 16. The first fiber end 15 interfaces with air while the second fiber end 16 is polished and is adapted to optically couple with the single mode fiber 22 through physical contact.

Functionally, the optical signal propagates through the OCI along its optical axis 11. The optical signal enters the housing at the housing's second end 9 from a single mode optical fiber 22. As the optical signal leaves the single mode fiber and enters the connector, it passes directly into the second end 16 of an axially aligned multimode optical fiber 12. As a result of the fibers being in physical contact, the optical signal passes directly from the single mode fiber into the multimode fiber thereby minimizing reflectance. In practice, the physical contact between the multimode and single mode fibers produce a continuous matched-refractive index path with a reflectance of less than about −30 dB. The optical signal propagates from the relatively narrow diameter wave guide core of a single mode fiber into the relatively wide diameter wave guide core of the multimode fiber.

At the first end 15 of the multimode fiber, the light meets the fiber/air interface. Although a certain amount of light will be refracted due to the difference in the refractive indexes of air and fiber, this light will not likely couple with the single mode fiber. That is, since the multimode fiber supports many modes of light other than the fundamental mode, and since only the fundamental mode can couple with a single-mode fiber, it is probable that the reflective light will not be in a mode suitable for coupling with the single-mode fiber. Thus, the multimode fiber acts as a one-way valve for light at the multimode fiber/single-mode fiber interface.

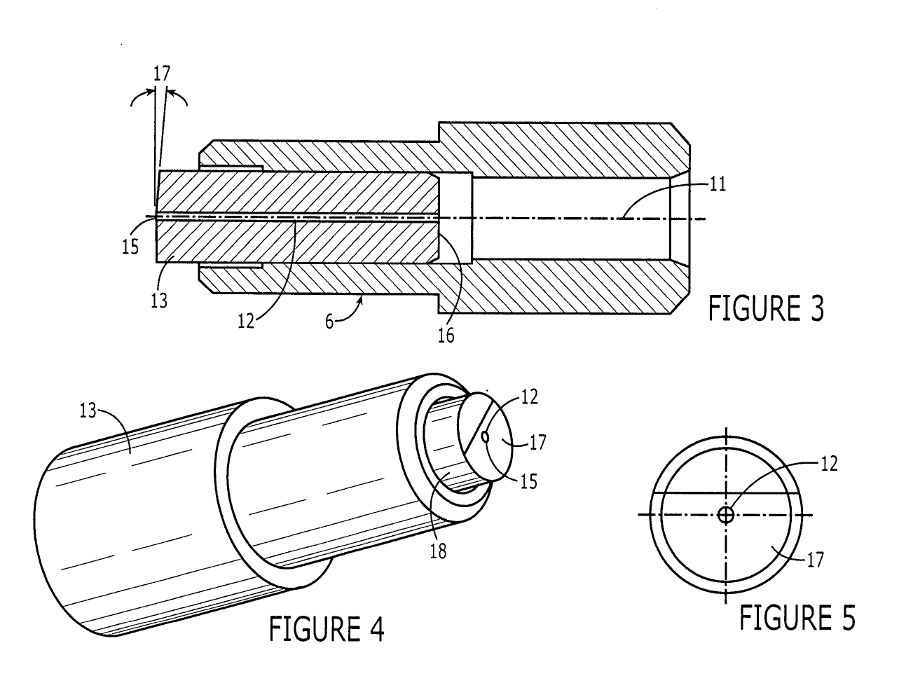

Reflectance is further reduced by polishing the first end of the multimode fiber 15 to produce a non-orthogonal angle 17 with respect to the optical axis. (See FIGS. 3-5). In the present invention, this uniform planar angle is the interface between the multimode optical fiber medium and the ambient medium 19 existing between the multimode fiber and the ball lens 14 (see FIG. 2). The angle minimizes the reflectance that occurs due to the difference in refractive indices at the glass-air interface. Specifically, the angle directs reflected light into the fiber's cladding 18 in a manner that allows the cladding to absorb the light, thereby reducing he reflectance that might ultimately reach the single mode optical fiber. For example, the first fiber end may be polished at a 4° angle with respect to a plane orthogonal to the optical axis. By angling the interface, reflectance can be reduced to less than about −30 dB.

After the optical signal leaves the multimode fiber, it propagates through a small air gap and then passes through the ball lens 14 which is positioned along the optical axis 11 in the first cavity 8 of the first end 7 of the housing assembly. The ball lens is a small glass bead that focuses light in a nearly uniform spot along the optical axis. In this embodiment, the lens 14 is configured to focus the optical beams on an OED that is mounted to a header (not shown) which is secured to the first end 7 of the housing. Preferably, the OED is a photodiode.

Although, in this embodiment, the first cavity 8 houses a ball lens for optically coupling with a photodiode on a header, other configurations are possible. For example, the second cavity could be configured to receive or be received in a mating connector. Such a configuration may be desirable, for example, in expanded beam connector applications. Regardless of the particular application, the combination of some or all of the features of the present invention provide for a low cost optical coupling and optical package that substantially reduces reflectance.

1. An optical coupling comprising a multimode fiber, a single mode fiber, and an air gap, wherein said multimode fiber is interposed between said single mode fiber and said air gap to produce a first interface between said multimode fiber and said single mode fiber and a second interface between said multimode fiber and said air gap.

2. The optical coupling of claim 1, wherein said multimode fiber at said second interface is polished at a uniform planar angle to reduce reflectance.

3. The optical coupling of claim 1 further comprising:
an optical axis; and
a housing having a first cavity for receiving an optical component along said axis and a second cavity for receiving said single mode fiber along said optical axis;
wherein said multimode fiber is disposed within said housing between said first and second cavities and along said optical axis.

4. The optical coupling of claim 3 wherein said multimode fiber has a first fiber end interfacing with air and having a second fiber end polished to optically couple with said single mode fiber through physical contact.

5. The optical coupling of claim 3, wherein said housing is integrally formed.

6. The optical coupling of claim 3, wherein said multimode fiber is contained in a ferrule stub.

7. The optical coupling of claim 3, wherein said optical component is a ball lens along the optical axis.

8. The optical coupling of claim 7, wherein said first end is secured to a header containing a photodiode.

9. The optical coupling of claim 3, wherein said optical component is a mating connector.

10. The optical coupling of claim 3, said first fiber end is polished at a uniform planar angle that is non-orthogonal to said optical axis.

11. The optical coupling of claim 10, wherein said uniform planar angle reduces reflectance occurring at the fiber-air interface.

12. The optical coupling of claim 11, wherein said uniform planar angle directs a portion of light reflected at said first fiber end into the cladding of said multimode fiber.

13. An optical package comprising:
an optical axis;
a housing having a first cavity for receiving an optical component along said axis and a second cavity for receiving a single mode fiber along said optical axis; and
a section of a multimode fiber disposed between said first and second cavities and along said optical axis, said multimode fiber having a first fiber end interfacing with air and having a second fiber end polished to optically couple with said single mode fiber through physical contact;
an optical component disposed in said first cavity; and
a single mode fiber disposed within said second cavity.

14. The optical package of claim 13, wherein said optical package is an optical connector interface.

15. The optical package of claim 13, further comprising:
a header containing an optoelectric device and being connected to said first end of said housing.

16. The optical package of claim 15, wherein said optical package is a TO-can.

17. The optical package of claim 16, wherein said TO-can is a receiver.

18. The optical package of claim 13, wherein said housing is integrally formed.

19. The optical package of claim 13, wherein said multimode fiber is contained in a ferrule stub.

20. The optical package of claim 13, wherein said optical component is a ball lens.

21. The optical package of claim 13, wherein said optical component is a mating connector.

22. The optical package of claim 13, said first fiber end is polished at a uniform planar angle that is non-orthogonal to said optical axis.

23. The optical package of claim 22, wherein said uniform planar angle reduces reflectance occurring at the core-air interface.

24. The optical package of claim 23, wherein the uniform planar angle directs a portion of light reflected at said first fiber end into the cladding of said multimode fiber.
